(19) United States
(12) Patent Application Publication
(10) Pub. No.: US 2012/0221166 A1
(43) Pub. Date: Aug. 30, 2012

(54) INFORMATION PROCESSING APPARATUS AND FAN CONTROL METHOD

(76) Inventor: Yoshiki Fukuda, Akishima-shi (JP)

(21) Appl. No.: 13/308,370

(22) Filed: Nov. 30, 2011

(30) Foreign Application Priority Data
Feb. 28, 2011 (JP) 2011-042476

(51) Int. Cl. G05D 23/19

(52) U.S. Cl. 700/300

(57) ABSTRACT

According to one embodiment, an information processing apparatus includes a housing, a heating element, a heating dissipating member, a fan and a controller. The heating element is disposed inside the housing. The heat dissipating member is attached to the heating element. The fan is disposed in the housing and configured to air-cool the heating element and the heat dissipating member. The controller is configured to control a rotational frequency of the fan. The controller includes a first control mode in which the rotational frequency of the fan is controlled so that a temperature of the heating element becomes not less than a certain temperature, and a second control mode in which the rotational frequency of the fan so that the temperature of the heating element becomes lower than the certain temperature.

### CROSS REFERENCE TO RELATED APPLICATION(S)

This application is based upon and claims the benefit of priority from Japanese Patent Application No. 2011-042476 filed on Feb. 28, 2011, the entire contents of which are incorporated herein by reference.

### FIELD

Embodiments described herein relate generally to an information processing apparatus and a fan control method.

### BACKGROUND

In recent years, CPUs (central processing units) used for information processing apparatuses such as computers have significantly increased in performance, and the amount of heat generation is rapidly increasing accordingly. As methods for cooling heating elements such as the CPUs, cooling technologies are used such as natural cooling by only a heat dissipating fin, forced air cooling using a fan, and water cooling using cooling water.

In all of these cooling systems, a heat dissipating member is made in close contact with the heating element through a grease, a silicon compound or the like having thermal conductivity. Such a thermal conductive member frequently has powerful adhesion to thermally connect between the heat dissipating member and the heating element. A heat dissipating sheet that reduces such adhesion has also been devised.

It is becoming necessary to replace the heating element such as the CPU in the maintenance and the like of information processing apparatuses such as computers. In such a case, there is a possibility that the heat dissipating member cannot easily be detached from the heating element because of the adhesion of the thermal conductive member. In particular, if the temperature of the thermal conductive member is low, the heat dissipating member is not easily detached, and forcibly detaching it can damage the CPU or the socket of the CPU.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary perspective view showing an outline of an information processing apparatus 1 in an embodiment;

FIG. 2 is an exemplary system configuration view of the information processing apparatus 1 according to the embodiment;

FIG. 3 is an exemplary perspective view showing an example of the condition where a heat dissipating member is attached to a CPU;

FIG. 4 is an exemplary side view of the heat dissipating member and the CPU; and

FIG. 5 is an exemplary flowchart showing the operation procedure of the cooling fan control processing in the embodiment.

### DETAILED DESCRIPTION

In general, according to one embodiment, an information processing apparatus includes a housing, a heating element, a heating dissipating member, a fan and a controller. The heating element is disposed inside the housing. The heat dissipating member is attached to the heating element. The fan is disposed in the housing and configured to air-cool the heating element and the heat dissipating member. The controller is configured to control a rotational frequency of the fan. The controller includes a first control mode in which the rotational frequency of the fan is controlled so that a temperature of the heating element becomes not less than a certain temperature, and a second control mode in which the rotational frequency of the fan so that the temperature of the heating element becomes lower than the certain temperature.

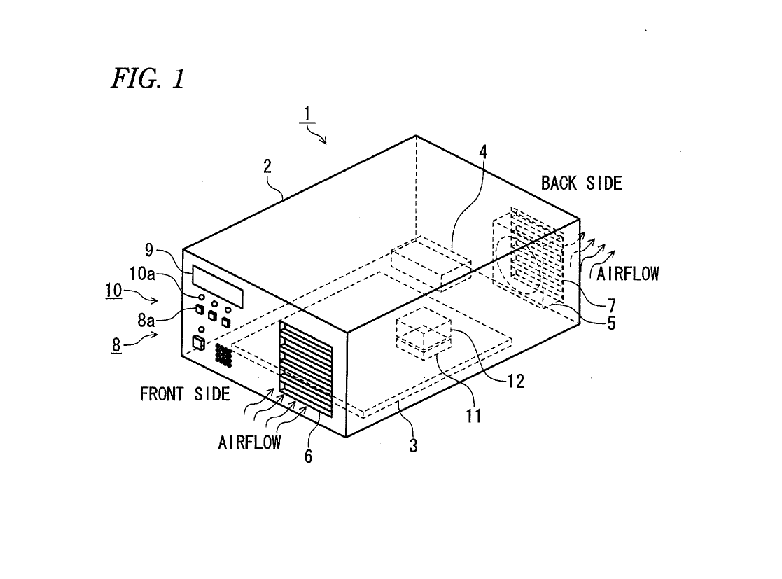

Hereinafter, exemplary embodiments will be described with reference to the drawings. FIG. 1 is a perspective view showing an outline of an information processing apparatus 1 in the embodiment. The information processing apparatus 1 is an information apparatus such as a server apparatus or a personal computer, and includes a housing 2, a main circuit board 3, a power circuit 4, a cooling fan 5, an inlet 6, an outlet 7, an operation module 8, a display module 9, and an indicator LED 10. The operation module 8, the display module 9, and the indicator LED 10 are disposed on the front surface of the information processing apparatus 1. Although storage units such as an HDD (hard disk drive), an SSD (solid state drive) and a memory card recording and reproducing device which are other parts included in the information processing apparatus 1 are disposed within the housing 2, these are omitted in FIG. 1.

The main circuit board 3 is mounted with a heating element 11 and a heat dissipating member 12. The heating element 11 is a processor unit such as a CPU. While not only the processor unit such as the CPU but also the power circuit 4, storage units and the like are provided as parts that generate heat within the housing 2, the heat generation amount of the CPU is particularly large, and the heat dissipating member 12 is frequently attached thereto.

The cooling fan 5 is disposed as an exhaust fan inside the outlet 7 provided on part of the housing 2. The cooling fan 5 may be disposed as an intake fan in the neighborhood of the inlet 6 for taking in outside air, or a plurality of cooling fans 5 may be disposed for both the inlet 6 and the outlet 7. Moreover, a cooling fan may be used that is disposed adjacent to or in close contact with the heat dissipating member.

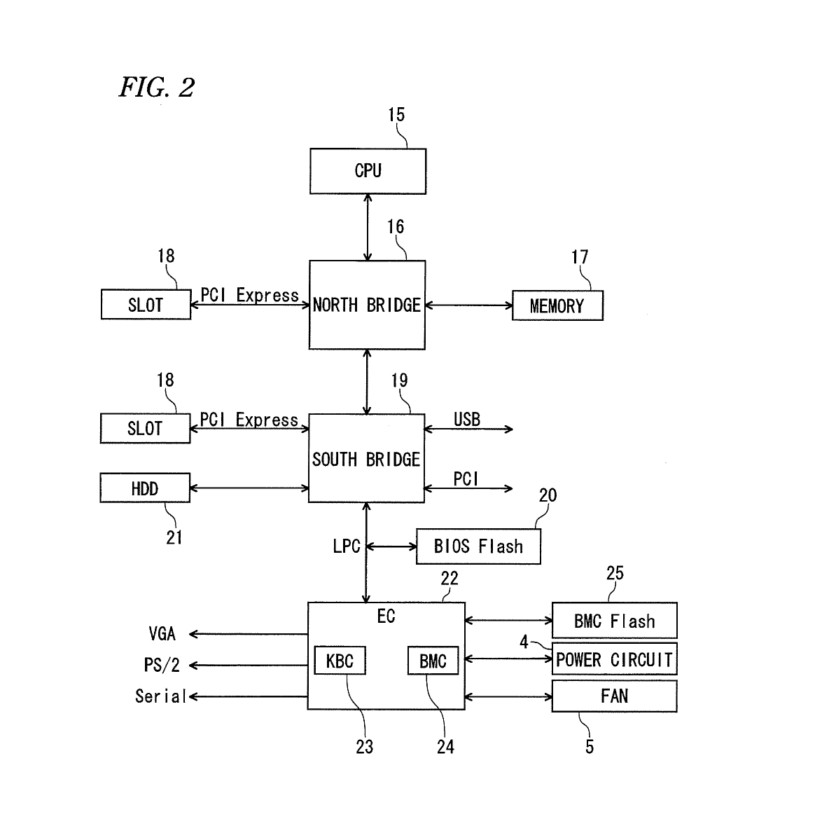

FIG. 2 is a system configuration view of the information processing apparatus 1 according to the present embodiment. The information processing apparatus 1 is provided with a CPU 15, a north bridge 16, a main memory 17, a PCIe (Peripheral Component Interconnect Express) slot 18, a south bridge 19, a BIOS (basic input output system) flash memory 20, an HDD 21, an embedded controller (EC) 22, and a BMC (baseband management controller) flash memory 25, the power circuit 4, and the cooling fan 5.

The CPU 15 is a processor provided to control the operation of the information processing apparatus 1, and executes the operating system (OS) loaded from the HDD 21 to the main memory 17 and various application programs. The main memory 17 is also used for storing various data buffers.

Moreover, the CPU 15 also executes the system BIOS stored in the BIOS flash memory 20. The system BIOS is a program for hardware control.

The north bridge 16 is a bridge device that connects between a local bus of the CPU 15 and the south bridge 19. The north bridge 16 incorporates a memory controller that controls access to the main memory 17. Moreover, the north bridge 16 also has the function of executing communication with a graphics controller and the like connected to the slot 18 through a PCIe bus or the like.

The south bridge 19 controls devices on an LPC (Low Pin Count) bus, a PCI (Peripheral Component Interconnect) bus, and a USB (Universal Serial Bus). Moreover, the south bridge 19 incorporates a PCIe controller for performing communication with a device connected to the PCIe bus. Further, the south bridge 19 has the function of controlling access to the BIOS flash memory 20. The HDD 21 stores the OS and various application programs.

The EC 22 is a one-chip microcomputer including the functions of a keyboard controller (KBC) 23 for controlling a keyboard (KB) and a mouse and a baseboard management controller (BMC) 24 for power control and temperature control. The KBC may be a controller called Super I/O. The BMC 24 has the function of turning on and off the power to the information processing apparatus 1 in response to an operation of the power switch by the user in concert with the power circuit 4. The EC 22 may be mounted on the main circuit board 3 or disposed on a different board.

The BMC 24 is a controller that monitors the power and voltage of the power circuit 4, monitors the temperatures of the power circuit 4, the inside of the housing, the CPU 15 and the neighborhood thereof, controls the cooling fan 5, and records hardware events. The BMC 24 is compliant with the industry standard IPMI (Intelligent Platform Management Interface) specifications. The BMC 24 monitors events by performing communication with a sensor such as a temperature sensor disposed within the housing or on the main circuit board, and, for example, transmits a warning and a log event when the temperature exceeds a threshold. The BMC control program is stored in the BMC flash memory 25.

In the neighborhood of the CPU 15, a temperature sensor that measures the temperature of the CPU 15 is provided, and when the information processing apparatus 1 is in operating state, the BMC 24 receives information from the temperature sensor to control the rotation of the cooling fan 5. For example, when the control mode of the cooling fan 5 is a standard mode, the BMC 24 controls the rotation of the cooling fan 5 so that the temperature of the CPU 15 becomes lower than a certain temperature, and when the control mode is a CPU replacement mode, the BMC 24 controls the rotation of the cooling fan 5 so that the temperature of the CPU 15 becomes not less than the certain temperature.

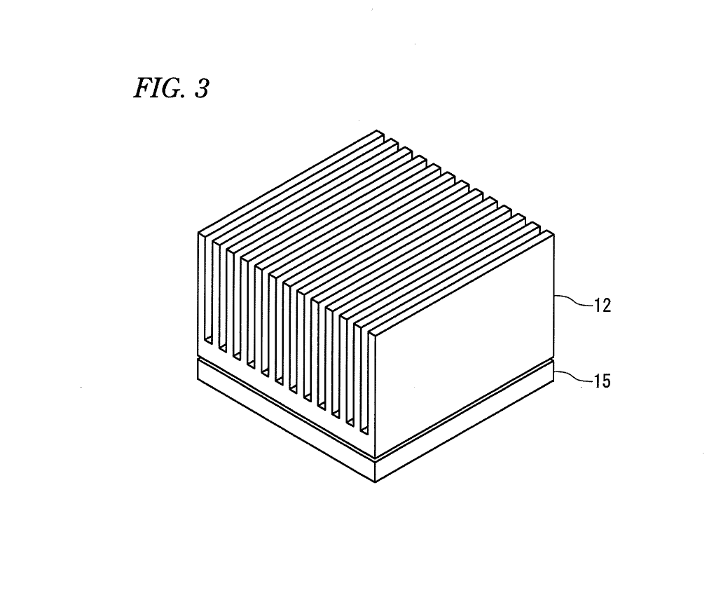

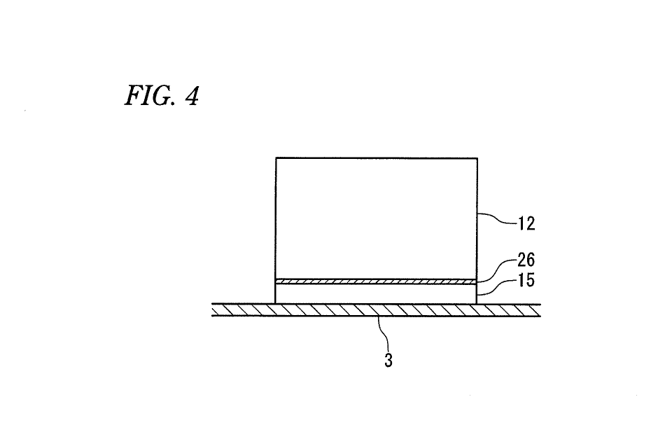

FIG. 3 is a perspective view showing an example of the condition where the heat dissipating member 12 is attached to the CPU 15 which is a heating element. The heat dissipating member 12 is formed of a metallic material such as aluminum or copper provided with a plurality of heat dissipating fins. FIG. 4 is a side view of the heat dissipating member 12 and the CPU 15. Between the heat dissipating member 12 and the CPU 15, a thermal conductive member 26 is interposed. The thermal conductive member 26 is provided for enhancing thermal conductivity by filling in a minute gap at the junction of the heat dissipating member 12 and the CPU 15 to be in close contact with the heat dissipating member 12 and the CPU 15. The thermal conductive member 26 is, for example, a paste-form grease containing a silicon material.

The thermal conductive member 26 frequently has powerful adhesion to thermally connect between the heat dissipating member 12 and the CPU 15. Moreover, in many cases, it hardens to firmly adhere when the temperature decreases. Some soften to decrease in adhesion when the temperature increases.

When it becomes necessary to detach the CPU 15 in the maintenance or the like of the information processing apparatus 1, there are cases where the heat dissipating member 12 cannot easily be detached because of the adhesion of the thermal conductive member 26. In such cases, by increasing the temperature of the thermal conductive member 26, the adhesion weakens so that the heat dissipating member 12 can comparatively easily be detached.

In the information processing apparatus 1, when the control mode of the cooling fan 5 is the standard mode (second control mode), the BMC 24 controls the rotation of the cooling fan 5 so that the temperature of the CPU 15 becomes lower than the certain temperature. Consequently, the temperature of the thermal conductive member 26 also becomes lower than the certain temperature. On the contrary, when the control mode of the cooling fan 5 is the CPU replacement mode (first control mode), the BMC 24 controls the rotation of the cooling fan 5 so that the temperature of the CPU 15 becomes not less than the certain temperature. The upper limit temperature of the CPU 15 in the standard mode may be set to a temperature (second temperature) still lower than the above-mentioned certain temperature, and a control mode in which such control is performed may be provided as a third control mode.

For example, it is considered to rotate the cooling fan 5 at the lowest controllable rotational frequency so that the temperature of the CPU 15 gradually increases to become not less than the certain temperature. If the temperature of the CPU 15 is increased without the cooling fan 5 being rotated at all, the temperature abruptly increases to largely exceed the certain temperature and this can damage the CPU 15. Therefore, it is more desirable to gradually increase the temperature of the CPU 15 while continuously rotating the cooling fan 5 at a low rotational frequency or performing control to intermittently rotate the cooling fan 5.

When the temperature of the CPU 15 becomes not less than the certain temperature, the temperature of the thermal conductive member 26 also becomes not less than the certain temperature, so that the heat dissipating member 12 can easily be detached. Consequently, the heat dissipating member 12 can easily be detached from the heating element 11 (CPU 15).

When changing the control mode of the cooling fan 5 from the standard mode (second control mode) to the CPU replacement mode (first control mode), the user presses a dedicated operation button (fan control button 8a) of the operation module 8 on the front surface of the housing 2. To prevent the control mode from being changed unintentionally, a structure may be adopted in which the control mode is changed when the operation button is continuously pressed for a certain time. Moreover, another operation button may be used also as the fan control button without the provision of the dedicated button 8a.

On the front surface of the housing 2, an indicator LED 10a is provided that provides a notification that the control mode has shifted from the standard mode (second control mode) to the CPU replacement mode (first control mode). The indicator LED 10a lights up when a shift to the first control mode is made. The indicator LED 10a blinks when the temperature of the CPU 15 becomes not less than the certain temperature.

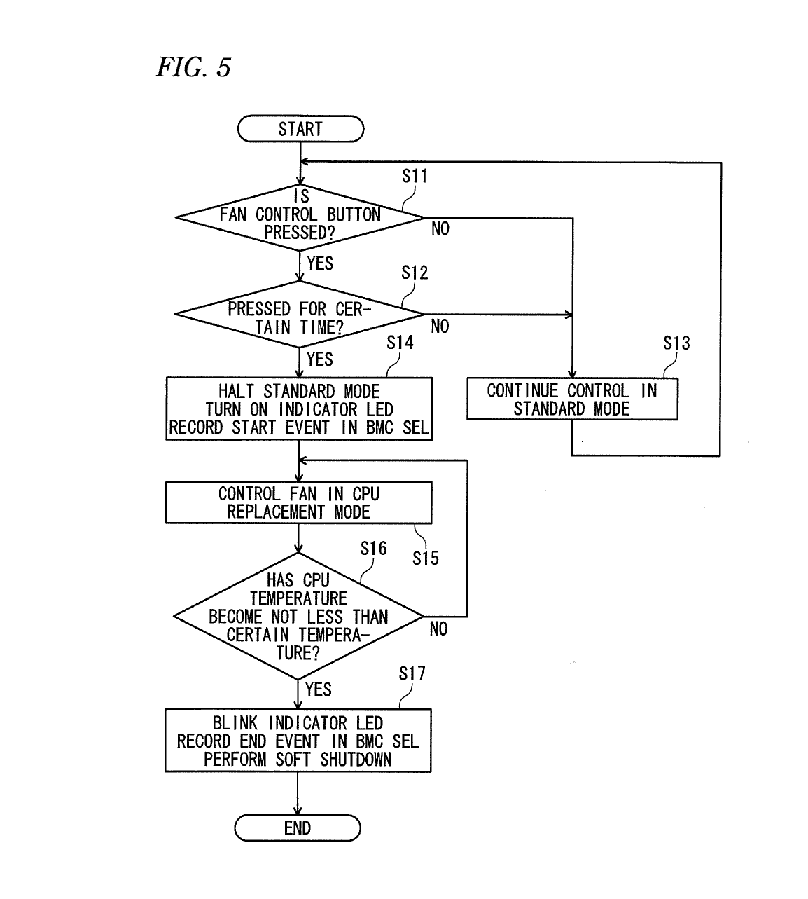

FIG. 5 is a flowchart showing the operation procedure of the cooling fan control processing in the embodiment. The cooling fan control processing is started when the information processing apparatus 1 is brought into operating state, and at first, it is controlled in the standard mode (second control mode) which is the default mode. Therefore, the temperature of the CPU 15 does not reach the certain temperature.

At S11, the BMC 24 determines whether the fan control button 8a is pressed by the user or not. When it is pressed, the process shifts to S12. When it is not pressed, the process shifts to S13, and the BMC 24 continues control in the standard mode. Then, the process returns to S11.

At S12, the BMC 24 determines whether the fan control button 8a is continuously pressed by the user for the certain time or not. The certain time is, for example, approximately four to five seconds. When it is continuously pressed, the process shifts to S14. When it is not continuously pressed, the process shifts to S13, and the BMC 24 continues control in the standard mode. Then, the process returns to S11.

At S14, the BMC 24 halts the standard mode, and turns on the indicator LED 10a. Further, the BMC 24 records the start event in a BMC SEL (system event log). An event is a function of detecting the occurrence of a specific state to be managed. When detecting an event, the BMC 24 records it into the SEL. The user can monitor the state of the information processing apparatus 1 by checking the SEL.

At S15, the BMC 24 controls the cooling fan 5 in the CPU replacement mode (first control mode).

At S16, the BMC 24 determines whether the temperature of the CPU 15 has become not less than the certain temperature or not. When the temperature has become not less than the certain temperature, the process shifts to S17. When the temperature has not become not less than the certain temperature, the process returns to S15.

At S17, the BMC 24 blinks the indicator LED 10a. Further, the BMC 24 records the end event into the SEL. The BMC 24 turns off the power circuit 4 to end the cooling fan control processing. Turning off the power circuit 4 is bringing the information processing apparatus 1 from operating state to standby state.

As described above, the following control modes are provided: the first control mode (CPU replacement mode) in which the rotation of the cooling fan 5 is controlled so that the temperature of the heating element 11 (CPU 15) becomes not less than the certain temperature; and the second control mode (standard mode) in which the rotation of the cooling fan 5 is controlled so that the temperature of the heating element 11 (CPU 15) becomes lower than the certain temperature. When the CPU 15 is replaced, by controlling the cooling fan in the first control mode (CPU replacement mode) so that the temperature of the heating element 11 (CPU 15) becomes not less than the certain temperature, the thermal conductive member 26 also becomes not less than the certain temperature, so that the heat dissipating member 12 can easily be detached.

By doing this, the user can significantly reduce the time required for the replacement of the CPU. Moreover, since a production tool to heat the thermal conductive member 26 is unnecessary and control can be changed by operating the fan control button 8a provided on the front surface of the apparatus, equipment such as a keyboard for inputting commands and a monitor is unnecessary. Here, when the information processing apparatus 1 is, for example, a server apparatus and provides client terminals or the like with services, it is necessary to avoid a halt of the server apparatus as much as possible from the viewpoint of the continuity and reliability of the services. For this reason, when the information processing apparatus 1 is a server apparatus, the effects are extremely remarkable.

While certain embodiments have been described, these embodiments have been presented by way of example only, and are not intended to limit the scope of the invention. Indeed, the novel apparatus and method described herein may be embodied in a variety of other forms; furthermore, various omissions, substitutions and changes in the form of the apparatus and method, described herein may be made without departing from the sprit of the invention. The accompanying claims and their equivalents are intended to cover such forms or modifications as would fall within the scope and sprit of the invention

What is claimed is:

1. An information processing apparatus comprising:
a housing;
a heating element disposed inside the housing;
a heat dissipating member attached to the heating element;
a fan disposed in the housing and configured to air-cool the heating element and the heat dissipating member; and
a controller configured to control a rotational frequency of the fan,
wherein the controller comprises a first control mode in which the rotational frequency of the fan is controlled so that a temperature of the heating element becomes not less than a certain temperature, and a second control mode in which the rotational frequency of the fan so that the temperature of the heating element becomes lower than the certain temperature.

2. The apparatus of claim 1, wherein the controller is configured to turn off power when the temperature of the heating element becomes not less than the certain temperature.

3. The apparatus of claim 1, wherein the housing comprises an operation button to make a shift to the first control mode.

4. The apparatus of claim 3, wherein the controller is configured to make the shift to the first control mode when the operation button is pressed for not less than a certain time.

5. The apparatus of claim 1, wherein the housing comprises an indicator LED configured to provide a notification that a shift to the first control mode has been made.

6. The apparatus of claim 5, wherein the controller is configured to turn on the indicator LED when the shift to the first control mode has been made.

7. The apparatus of claim 5, wherein the controller is configured to blink the indicator LED when the temperature of the heating element becomes not less than the certain temperature.

8. A fan control method of an information processing apparatus comprising a housing, a heating element disposed inside the housing, a heat dissipating member attached to the heating element, and a fan disposed in the housing and configured to air-cool the heating element and the heat dissipating member, the method comprising:
controlling a rotational frequency of the fan in a first control mode or a second control mode,
wherein in the first control mode, the rotational frequency of the fan is controlled so that a temperature of the heating element becomes not less than a certain temperature, and in the second control mode, the rotational frequency of the fan is controlled so that the temperature of the heating element becomes lower than the certain temperature.
